(19) United States
(12) Patent Application Publication
(10) Pub. No.: US 2009/0208816 A1
(43) Pub. Date: Aug. 20, 2009

(54) PROPERLY POSITIONING STACKED PLATE ELECTRODE FOR HIGH VOLUME ASSEMBLY

(76) Inventors: Joseph J. Viavattine, Vadnais Heights, MN (US); Kevin R. Aufderhar, Coon Rapids, MN (US)

Correspondence Address: MEDTRONIC, INC., 710 MEDTRONIC PARKWAY NE, MINNEAPOLIS, MN, 55432-9924, US

(21) Appl. No.: 12/023,799

(22) Filed: Jan. 31, 2008

(51) Int. Cl. H01M 10/44; H01M 2/26; H01M 4/82

(52) U.S. Cl. 429/50; 429/161; 29/623.1

(57) ABSTRACT

An electrode in an electrochemical cell for an implantable medical device is presented. The electrode includes a plurality of electrode plates. Each electrode plate includes a tab extending therefrom. The tab is shaped in a H-shape, a T-shape, a Y-shape, and a L-shape.

### CROSS-REFERENCE TO RELATED APPLICATION

The present application claims priority and other benefits from U.S. application Ser. No. 11/701,329 filed Jan. 31, 2007, and requested to be converted to a provisional application on Jan. 30, 2008, the disclosure of which is incorporated herein by reference in its entirety.

### FIELD OF THE INVENTION

The present invention generally relates to an electrochemical cell for an implantable medical device, and, more particularly, to a current collector used in an electrode plate for an electrochemical cell.

### BACKGROUND OF THE INVENTION

Implantable medical devices (IMDs) detect and deliver therapy for a variety of medical conditions in patients. IMDs include implantable pulse generators (IPGs) or implantable cardioverter-defibrillators (ICDs) that deliver electrical stimuli to tissue of a patient. ICDs typically comprise, inter alia, a control module, a capacitor, and a battery that are housed in a hermetically sealed container. When therapy is required by a patient, the control module signals the battery to charge the capacitor, which in turn discharges electrical stimuli to tissue of a patient.

The battery includes a case, a liner, an electrode assembly, and electrolyte. The liner insulates the electrode assembly from the case. The electrode assembly includes electrodes, an anode and a cathode, with a separator therebetween. For a flat plate battery, an anode comprises a set of anode electrode plates with a set of tabs extending therefrom. The set of tabs are electrically connected. Each anode electrode plate includes a current collector with anode material disposed thereon. A cathode is similarly constructed.

For a flat plate battery, an electrode (i.e. an anode, a cathode) comprises a set of electrode plates with a set of tabs extending therefrom that are electrically connected. During assembly, straight tabs can sometimes be difficult to quickly and properly position in a stack assembly nest of an apparatus used to assemble the electrode. Tabs that are not properly positioned can be inadequately connected which can cause the electrode assembly to be scrapped. It is therefore desirable to overcome this disadvantage in order to reduce manufacturing costs.

### BRIEF DESCRIPTION OF THE DRAWINGS

The present invention will become more fully understood from the detailed description and the accompanying drawings, wherein:

FIG. 1 is a cutaway perspective view of an implantable medical device (IMD);

FIG. 2 is a cutaway perspective view of a battery (or cell) in the IMD of FIG. 1;

FIG. 3A is an enlarged view of a portion of an electrode assembly depicted in FIG. 2;

FIG. 3B is a cross-sectional view of a portion of an electrode assembly depicted in FIG. 2;

FIG. 4A is an angled cross-sectional view of a current collector in an electrode plate of the electrode assembly depicted in FIG. 3A;

FIG. 4B is an angled cross-sectional view of the electrode plate that includes the current collector depicted in FIG. 4A along with electrode material disposed thereon;

FIG. 5 is a top view of a current collector;

FIG. 6 is a top view of a current collector with a T-shaped tab;

FIG. 7 is a top view of a current collector with a L-shaped tab;

FIG. 8 is a top view of a current collector with a Y-shaped tab;

FIG. 9 is a top view of a current collector with a H-shaped tab;

FIG. 10A is a top view of a H-shaped tab;

FIG. 10B is an angled view of a H-shaped tab;

FIG. 11A is a top view of a double T-shaped tab;

FIG. 11B is an angled view of a double T-shaped tab;

FIG. 12A is a perspective view of stacked electrode plates with a T-shaped tab; and

FIG. 12B is an angled perspective view of stacked electrode plates with a T-shaped tab.

### DETAILED DESCRIPTION

The following description of embodiments is merely exemplary in nature and is in no way intended to limit the invention, its application, or uses. For purposes of clarity, the same reference numbers are used in the drawings to identify similar elements.

The present invention is directed to an electrode for a battery in an implantable medical device. The electrode includes a plurality of electrode plates. Each electrode plate includes a tab extending therefrom. The tab is configured in a profile that includes a H-shape, a T-shape, a Y-shape, or a L-shape. The spacers serve as a heat sink. The profiled tabs can also serve as a heat sink, but to a lesser extent (˜20% tab, 80% spacer). The profiled tabs serve as a “heat sink,” which allows for increased uniform energy transfer from the current collector to the set of tabs. Additionally, profiled tabs do not need to be bent in order to connect the set of tabs.

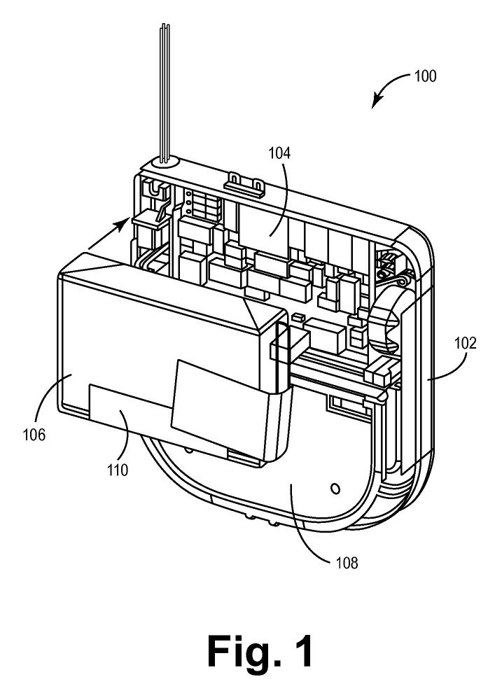

FIG. 1 depicts an IMD 100 (e.g. implantable cardioverter-defibrillators (ICDs) etc.). IMD 100 includes a case 102, a control module 104, a battery 106 (e.g. organic electrolyte battery etc.) and capacitor(s) 108. Control module 104 controls one or more sensing and/or stimulation processes from IMD 100 via leads (not shown). Battery 106 includes an insulator 110 (or liner) disposed therearound. Battery 106 charges capacitor(s) 108 and powers control module 104.

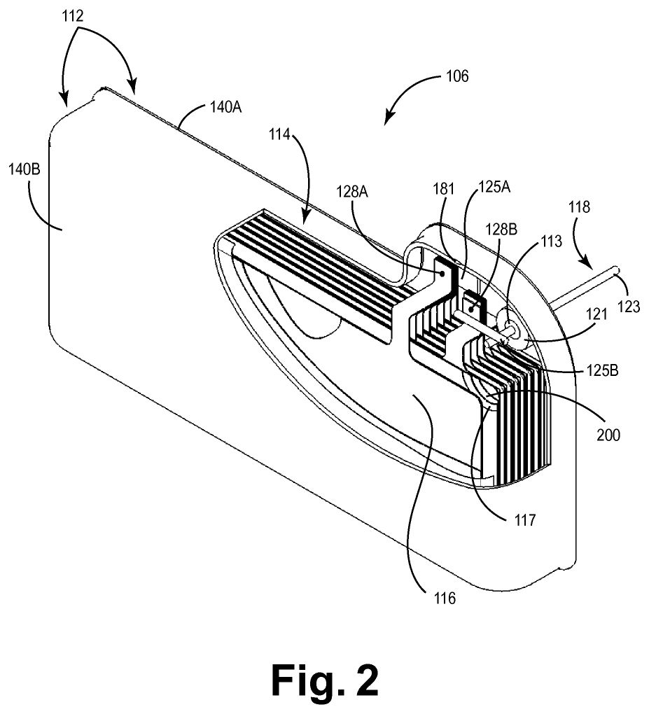

FIGS. 2 through 5 depict details of an exemplary organic electrolyte battery 106. Battery 106 includes an encasement 112, a feed-through terminal 118, a fill port 181 (partially shown), a liquid electrolyte 116, and an electrode assembly 114. Encasement 112, formed by a cover 140A and a case 140B, houses electrode assembly 114 with electrolyte 116. Feed-through assembly 118, formed by pin 123, insulator member 113, and ferrule 121, is electrically connected to jumper pin 125B. The connection between pin 123 and jumper pin 125B allows delivery of positive charge from electrode assembly 114 to electronic components outside of battery 106.

Fill port 181 (partially shown) allows introduction of liquid electrolyte 116 to electrode assembly 114. Electrolyte 116 creates an ionic path between anode 115 and cathode 119 of electrode assembly 114. Electrolyte 116 serves as a medium for migration of ions between anode 115 and cathode 119 during an electrochemical reaction with these electrodes.

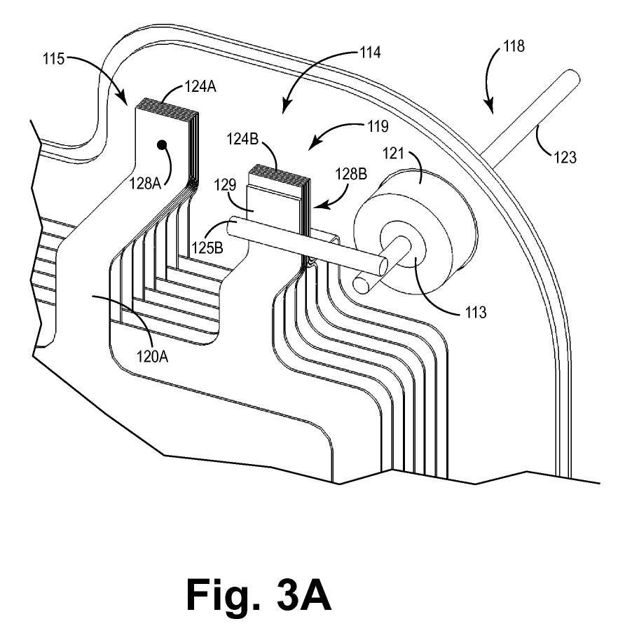

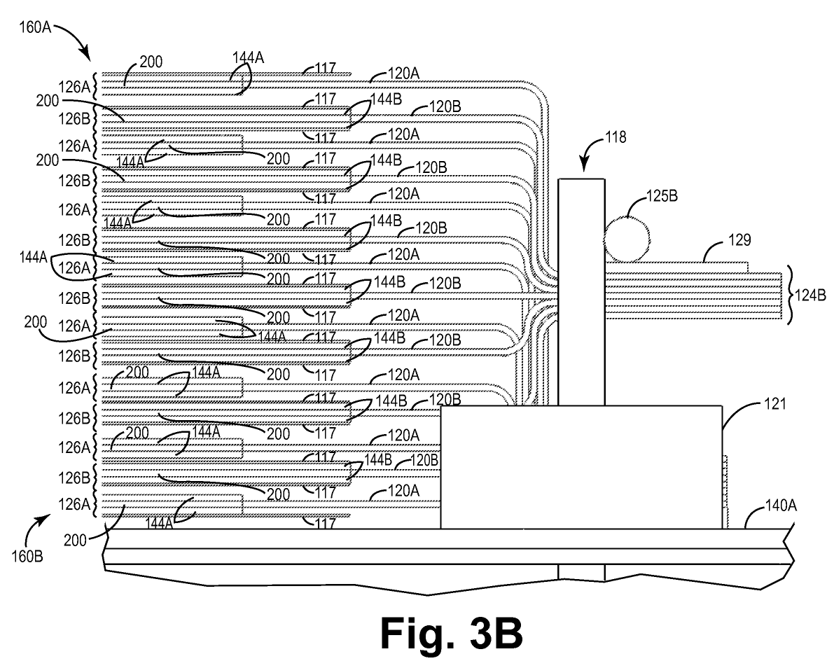

Referring to FIGS. 3A-3B, electrode assembly 114 is depicted as a stacked assembly. Anode 115 comprises a set of electrode plates 126A (i.e. anode electrode plates) with a set of tabs 124A that are conductively coupled via a conductive coupler 128A (also referred to as an anode collector). Conductive coupler 128A may be a weld or a separate coupling member. Optionally, conductive coupler 128A is connected to an anode interconnect jumper 125A, as shown in FIG. 2.

Each electrode plate 126A includes a current collector 200 or grid, a tab 120A extending therefrom, and electrode material 144A. Tab 120A comprises conductive material (e.g. copper, etc.). Electrode material 144A includes elements from Group IA, IIA or IIIB of the periodic table of elements (e.g. lithium, sodium, potassium, etc.), alloys thereof, intermetallic compounds (e.g. Li—Si, Li—B, Li—Si—B etc.), or an alkali metal (e.g. lithium, etc.) in metallic form. As shown in FIG. 3B, a separator 117 is coupled to electrode material 144A at the top and bottom 160A-B electrode plates 126A, respectively.

Cathode 119 is constructed in a similar manner as anode 115. Cathode 119 includes a set of electrode plates 126B (i.e. cathode electrode plates), a set of tabs 124B, and a conductive coupler 128B connecting set of tabs 124B. Conductive coupler 128B or cathode collector is connected to conductive member 129 and jumper pin 125B. Conductive member 129, shaped as a plate, comprises titanium, aluminum/titanium clad metal or other suitable materials. Jumper pin 125B is also connected to feed-through assembly 118, which allows cathode 119 to deliver positive charge to electronic components outside of battery 106. Separator 117 is coupled to each cathode electrode plate 126B.

Each cathode electrode plate 126B includes a current collector 200 or grid, electrode material 144B and a tab 120B extending therefrom. Tab 120B comprises conductive material (e.g. aluminum etc.). Electrode material 144B or cathode material includes metal oxides (e.g. vanadium oxide, silver vanadium oxide (SVO), manganese dioxide etc.), carbon monofluoride and hybrids thereof (e.g., CF_{X}+MnO₂), combination silver vanadium oxide (CSVO), lithium ion, other rechargeable chemistries, or other suitable compounds.

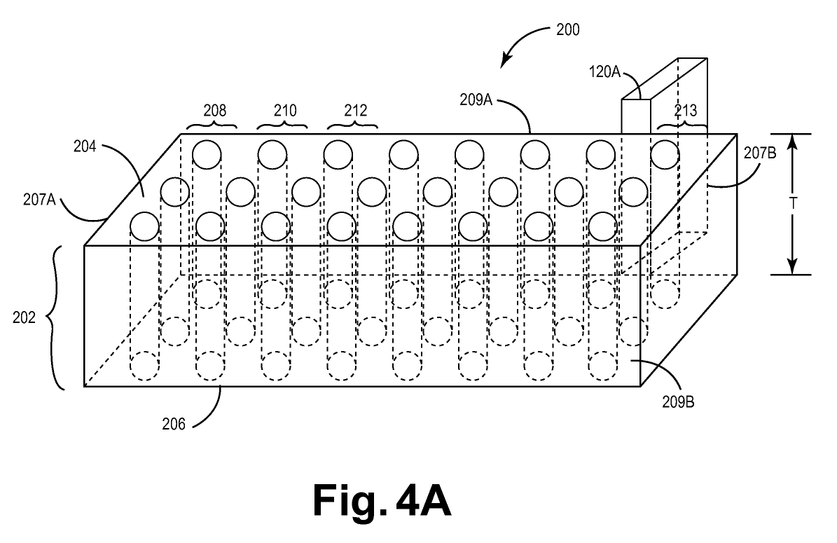

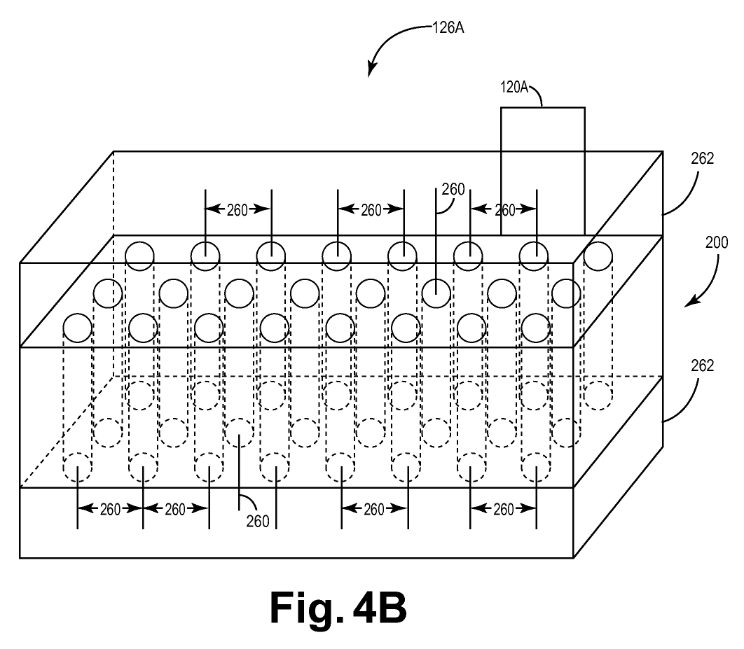

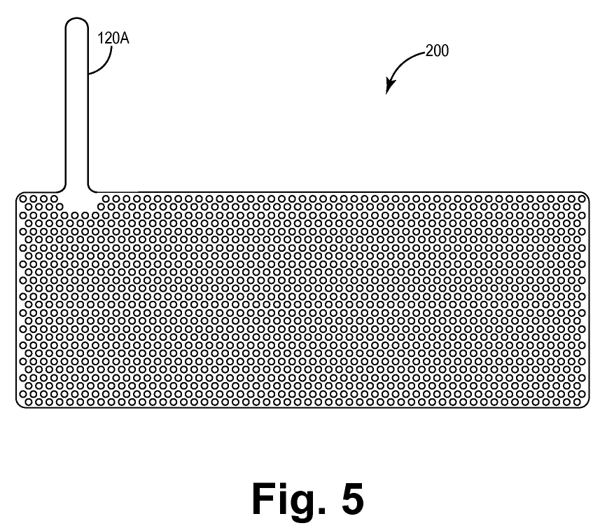

FIGS. 4A-4B and 5 depict details of current collector 200. Current collector 200 is a conductive layer 202 that includes a sides 207A, 207B, 209A, 209B, a first surface 204 and a second surface 206 with a connector tab 120A protruding therefrom. A first, second, third, and N set of apertures 208, 210, 212, 213, respectively, extend from first surface 204 through second surface 206. N set of apertures are any whole number of apertures. Conductive layer 202 may comprise a variety of conductive materials. Current collectors 202 for cathode 119 and tab 120B may be, for example, titanium, aluminum, nickel or other suitable materials. For an anode 115, current collector 200 and tab 120A comprise nickel, titanium, copper an alloy thereof or other suitable conductive material.

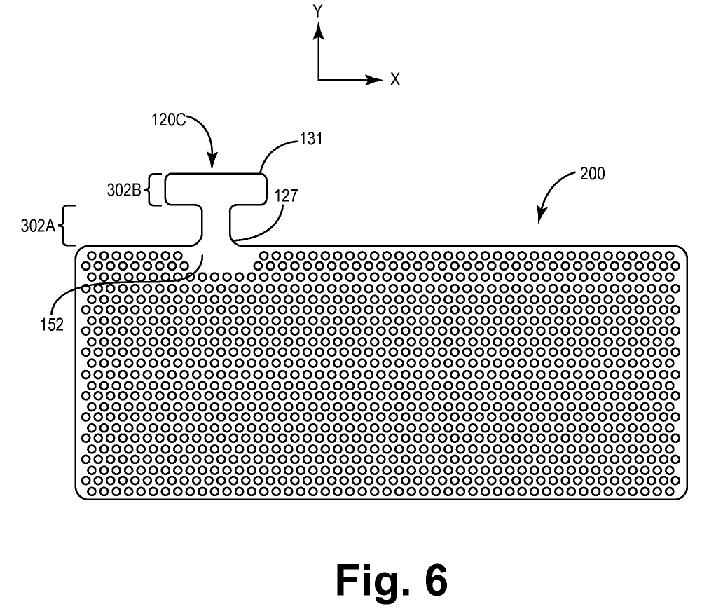

FIGS. 6-9 depict various embodiments involving differently shaped tabs for current collectors 200 that are used to quickly and properly align electrode plates in a stacking device during an assembly operation for an electrochemical cell such as a battery. Quickly locating and properly positioning electrode plates decreases the time needed to join tabs 120A or 120B through a welding operation (e.g. single laser welding operation etc.). The quality of the weld through set of tabs 120A or 120B is also enhanced since the precise alignment allows the welding operation to be repeated.

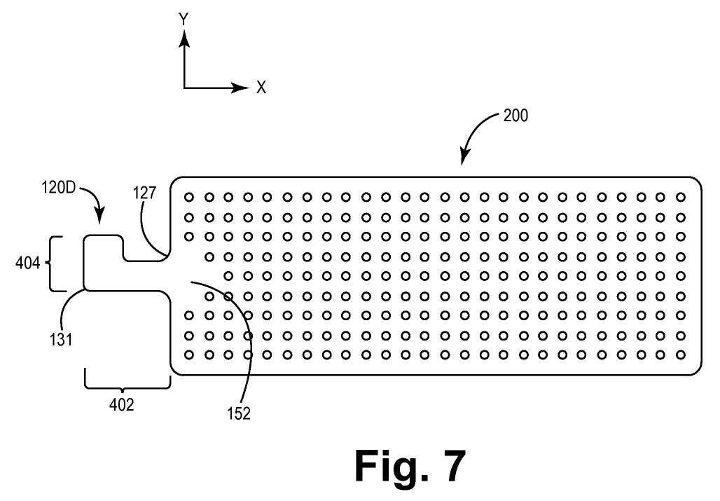

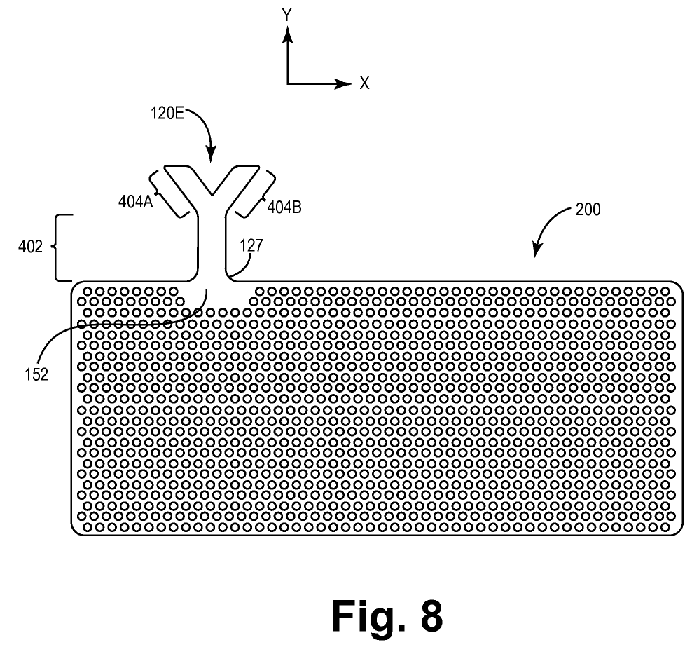

Each tab 120C-F includes a proximal end 127, located near base 152 of current collector 200, and a distal end 131 that extends away from base 152. Distal end 131 may comprise one or more legs 150A, B that are integrally formed to or with base 152. For example, T-shaped tab 120C, depicted in FIG. 6, includes a first and a second leg 302 A, B that are perpendicular to each other. FIG. 7 depicts L-shaped tab 120D. In this embodiment, tab 120D is integrally formed in a L-shape. In one embodiment, tab 120D can comprise a first and a second leg 402, 404 respectively that are perpendicular to one another. FIG. 8 depicts tab 120E configured in a Y-shape. In one embodiment, tab 120E comprises first, second, and third legs 404A, 404B and 402. First leg 404A and second leg 404B extend from third leg 402. First leg 404A can be positioned up to about 60 degrees (°) from the x-axis whereas second leg 404B can possess an angle up to about 150°. Another embodiment of the claimed invention can involve a single leg such as first leg 404A or second leg 404B extending from third leg 402.

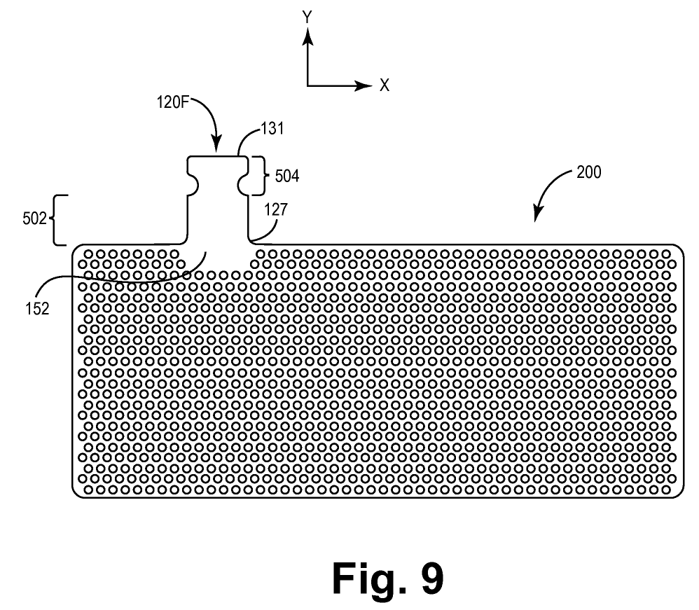

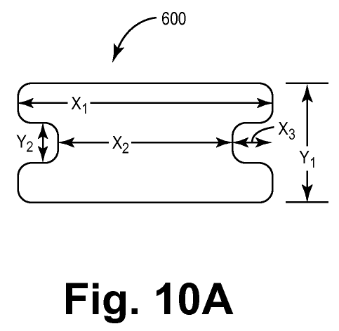

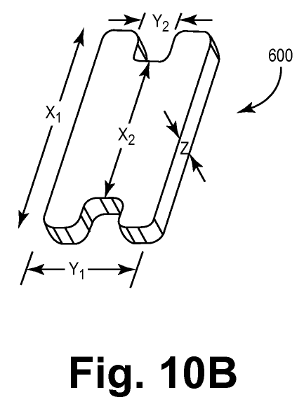

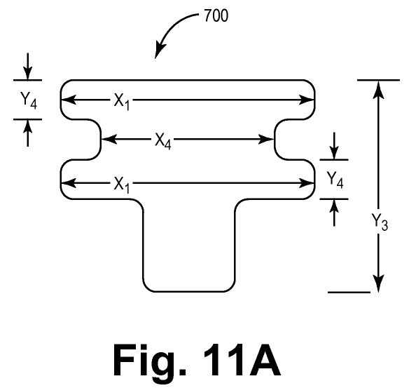

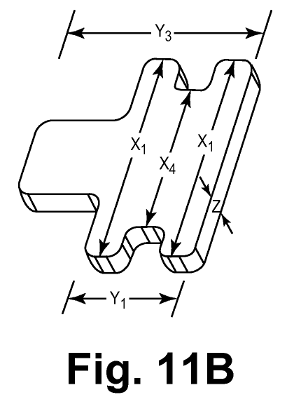

FIGS. 9-11B depict tab 120F, which is substantially double T-shaped, “hammer head” shaped, or H-shaped. Tab 120F is defined by first length X1, fifth length X4, sixth length Y3 and thickness Z. Exemplary values for tab 120F include X1=0.190 inches (in), X4=0.120 in, Y3=0.160 in, Y4=0.030 in, and Z=0.20 in

The geometric shape of the distal end 131 of tab 120C-F allow the electrode plates to be vertically stacked, which simplifies the assembly process. Additionally, a common platform can be achieved on which various families of stacked plate batteries could be built in volume with minor tooling changes.

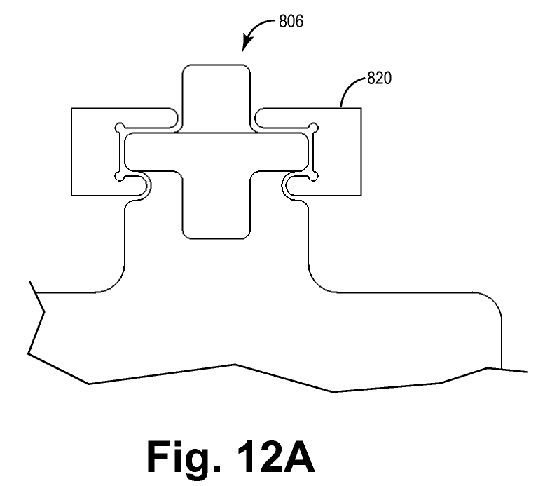

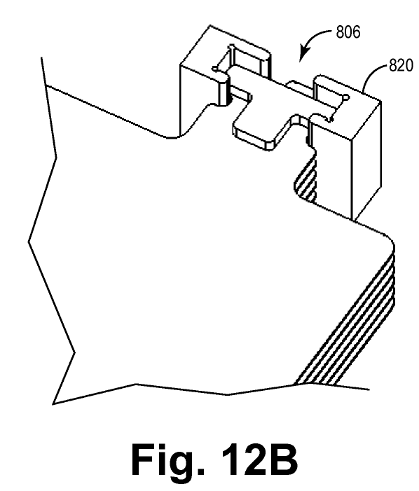

In one embodiment, stacking device, shown in FIGS. 12A-12B includes “profile rings” to match up with locating features incorporated into the tabs of the electrodes to locate the electrodes during stacking. The locating profile of the nest also acts as a barrier to protect the electrodes from potential laser damage during welding. In another embodiment, locating apertures can be formed in electrode tabs 120C-F to allow alignment over a locating pin or a connecting “rivet”. This can be a hole at the base or in the neck of the current collector tab which will fit over a post in a stacking fixture for the purpose of aligning the collectors.

Skilled artisans appreciate that alternative embodiments can be implemented using the principles described herein. For example, while the profiled tabs are generally described as a single integrally formed tab 120A-F, other embodiments contemplate coupling one or more legs 150A,B together or to base 152. In another embodiment, one of the tabs may be substantially circular. Substantially circular is defined as being within 10% of a particular shape such as a circle. The description of the invention is merely exemplary in nature and, thus, variations that do not depart from the gist of the invention are intended to be within the scope of the invention. Such variations are not to be regarded as a departure from the spirit and scope of the invention. For example, while several embodiments include specific dimensions, skilled artisans appreciate that these values will change depending, for example, on the shape of a particular element.

1. An electrode for an electrochemical cell in an implantable medical device comprising:
a plurality of electrode plates, wherein each electrode plate includes a tab extending therefrom, the tab being shaped as one of a H-shape, a T-shape, a Y-shape, and an L-shape.

2. The electrode of claim 1 wherein the tab includes a first leg at the proximal end and a second leg at the distal end.

4. The electrode of claim 1 wherein the first leg having a first end and a second end, the first end disposed at the proximal end of the tab and the second leg disposed at the second end of the first leg.

5. The electrode of claim 1 wherein the second leg being perpendicular to the first leg.

6. The electrode of claim 5 wherein the second leg being about less than 90 degrees from the first leg.

7. The electrode of claim 5 wherein the second leg being about greater than 90 degrees from the first leg.

8. The electrode of claim 1 wherein the tab comprises one of titanium, aluminum, and alloys thereof.

9. The electrode of claim 8 wherein the tab is configured for a cathode.

10. The electrode of claim 1 wherein the tab comprises one of nickel, titanium, copper, aluminum, and alloys thereof.

11. The electrode of claim 10 wherein the tab is configured for an anode.

12. Electrodes for a battery in an implantable medical device comprising:
a first set of anode electrode plates, wherein each anode electrode plate includes a tab extending therefrom, the tab being shaped as one of a H-shape, a T-shape, a Y-shape, and an L-shape, wherein the tab comprises at least one of nickel, titanium, copper, aluminum, alloys thereof; and
a second set of cathode electrode plates, wherein each cathode electrode plate includes a tab extending therefrom, the tab being shaped as one of a H-shape, a T-shape, a Y-shape, and an L-shape, wherein the tab comprises at least one of titanium, aluminum, and alloys thereof.

13. A method of forming an electrode for an electrochemical cell in an implantable medical device comprising:
providing a plurality of electrode plates;
coupling a tab to each electrode plate, the tab being shaped as one of a H-shape, a T-shape, a Y-shape, and an L-shape.

14. A method of forming an electrode for an electrochemical cell in an implantable medical device comprising:
providing a plurality of electrode plates; and
forming an integral tab to each electrode plate, the tab being shaped as one of a H-shape, a T-shape, a Y-shape, and an L-shape.

15. A method of using an electrode for an electrochemical cell in an implantable medical device comprising:
providing a plurality of electrode plates, wherein each electrode plate includes a tab extending therefrom, the tab being shaped as one of a H-shape, a T-shape, a Y-shape, and an L-shape.
